(19) United States
(12) Patent Application Publication
(10) Pub. No.: US 2025/0070907 A1
(43) Pub. Date: Feb. 27, 2025

(54) OPTICAL COMMUNICATION DEVICE THAT TRANSMITS WDM SIGNAL

(71) Applicant: Fujitsu Limited, Kawasaki-shi (JP)

(72) Inventor: Akio SUGAMA, Atsugi (JP)

(73) Assignee: Fujitsu Limited, Kawasaki-shi (JP)

(21) Appl. No.: 18/773,998

(22) Filed: Jul. 16, 2024

(30) Foreign Application Priority Data
Aug. 24, 2023 (JP) 2023-135952

(51) Int. Cl. H04J 14/02

(52) U.S. Cl. CPC H04J 14/0227; H04J 14/0205; H04J 14/0212

(57) ABSTRACT

Optical communication device includes reception circuit that receives first WDM signal in first wavelength band from first node and transmission circuit that transmits second WDM signal in the first wavelength band to second node. The reception circuit includes WSS (wavelength selective switch) and wavelength converter. The WSS guides optical signal to be transmitted to the second node in the first WDM signal to output port optically coupled to the transmission circuit. The WSS guides optical signal to be transmitted to access network in the first WDM signal to the wavelength converter. The wavelength converter performs wavelength conversion from the first wavelength band into second wavelength band. The WSS guides the wavelength-converted optical signal to output port optically coupled to the access network.

### CROSS-REFERENCE TO RELATED APPLICATION

This application is based upon and claims the benefit of priority of the prior Japanese Patent Application No. 2023-135952, filed on Aug. 24, 2023, the entire contents of which are incorporated herein by reference.

### FIELD

The embodiments discussed herein are related to an optical communication device that transmits a wavelength division multiplexing (WDM) signal.

### BACKGROUND

WDM transmission has been put into practical use to achieve large-capacity optical communication. WDM can transmit a plurality of optical signals via one optical fiber by multiplexing a plurality of wavelength channels. Each node of a WDM transmission system is provided with, for example, a reconfigurable optical add-drop multiplexer (ROADM). The ROADM can branch (or drop) an optical signal of a desired wavelength from a WDM signal. The branched optical signal is guided to, for example, an access network. In addition, the ROADM can insert (or add) an optical signal received from the access network into an unused channel of the WDM signal.

In the existing WDM transmission system, a conventional (C) band and/or a long wavelength (L) band are mainly used. A wavelength range of the C band is about 1530 to 1565 nm, and a wavelength range of the L band is about 1565 to 1625 nm. A plurality of wavelength channels are allocated in each wavelength band.

In recent years, WDM transmission using a short wavelength(S) band and/or an ultra-long wavelength (U) band in addition to the C band/L band has been studied to further increase the capacity of optical communication. A wavelength range of the S band is about 1460 to 1530 nm, and a wavelength range of the U band is about 1625 to 1675 nm.

However, an optical device (for example, an optical transceiver or the like) for processing an S-band/U-band optical signal has not yet been put into practical use. Alternatively, such an optical device is very expensive. Therefore, a ROADM including a wavelength converter has been proposed. For example, when the WDM transmission system transmits an optical signal by using a C band and an S band, the ROADM includes a wavelength converter that performs wavelength conversion between the S band and the C band. Alternatively, when the WDM transmission system transmits an optical signal by using an L band and a U band, the ROADM includes a wavelength converter that performs wavelength conversion between the U band and the L band. According to this configuration, it is possible to extend a communicable wavelength region while using an existing optical device. Note that a configuration in which a wavelength converter is provided in each node is described in, for example, Japanese Laid-open Patent Publication No. 2020-137042.

As described above, by providing a wavelength converter in the ROADM, the communicable wavelength region can be extended. However, in the conventional configuration, an optical signal-to-noise ratio (OSNR) may deteriorate due to noise generated in the wavelength converter. Therefore, in a case where the WDM signal passes through a plurality of nodes (that is, a plurality of ROADMs), there is a possibility that deterioration of the OSNR accumulates and communication quality deteriorates.

### SUMMARY

According to an aspect of the embodiments, an optical communication device, that processes a WDM signal in a WDM transmission system, includes: a reception circuit that receives a first WDM signal from a first node in the WDM transmission system; and a transmission circuit that transmits a second WDM signal to a second node in the WDM transmission system. The reception circuit includes: a wavelength filter that extracts a plurality of input optical signals allocated in a first wavelength band from the first WDM signal, a wavelength selective switch that has a first input port, a second input port, a plurality of output ports, and a wavelength conversion port, and an optical circuit including a wavelength converter optically coupled to the wavelength selective switch. The plurality of input optical signals are guided to the first input port. The wavelength selective switch guides an optical signal to be branched from the first WDM signal among the plurality of input optical signals to the wavelength conversion port. The optical circuit performs wavelength conversion from the first wavelength band to a second wavelength band on the optical signal output via the wavelength conversion port to generate a wavelength-converted optical signal. The wavelength-converted optical signal is guided to the second input port. The wavelength selective switch guides each of an optical signal to be transmitted to the second node among the plurality of input optical signals and the wavelength-converted optical signal to a corresponding output port among the plurality of output ports. The optical circuit guides an optical signal allocated in the first wavelength band among optical signals output via the plurality of output ports to the transmission circuit, and guides an optical signal allocated in the second wavelength band among the optical signals output via the plurality of output ports to an access network connected to the optical communication device.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of a WDM transmission system according to an embodiment of the present disclosure;

FIG. 2 illustrates an example of a configuration of a ROADM;

FIG. 3 illustrates an example of a ROADM including a wavelength converter for extending a wavelength region;

FIG. 4 illustrates an example of a WDM signal in which a wavelength region is extended;

FIG. 5 illustrates another example of a ROADM including a wavelength converter for extending a wavelength region;

FIG. 6 illustrates an example of a configuration of a ROADM according to the embodiment of the present disclosure;

FIG. 7 illustrates an example of a reception circuit and a transmission circuit implemented in the ROADM according to the embodiment of the present disclosure;

FIGS. 8A and 8B illustrate an example of an operation of the reception circuit;

FIGS. 9A and 9B illustrate an example of an operation of the transmission circuit;

FIG. 10 is a flowchart illustrating an example of a procedure for configuring an WSS in the ROADM;

FIGS. 11A and 11B each illustrate an example of a level and a noise figure of an optical signal transmitted by the ROADM;

FIG. 12 illustrates an effect according to the embodiment of the present disclosure;

FIGS. 13A and 13B illustrate an example of a reception circuit and a transmission circuit implemented in a ROADM according to a second embodiment;

FIGS. 14A and 14B illustrate an example of an operation of the reception circuit in the second embodiment;

FIGS. 15A and 15B illustrate an example of an operation of the transmission circuit in the second embodiment;

FIGS. 16A and 16B illustrate a variation of the second embodiment;

FIGS. 17A and 17B illustrate an example of a reception circuit and a transmission circuit implemented in a ROADM according to a third embodiment; and

FIGS. 18A and 18B illustrate examples of operations of the reception circuit and the transmission circuit in the third embodiment.

### DESCRIPTION OF EMBODIMENTS

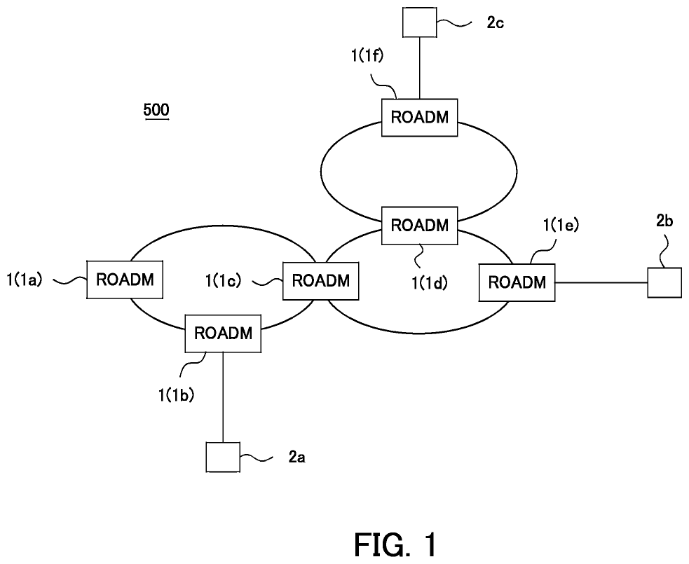

FIG. 1 illustrates an example of a WDM transmission system according to an embodiment of the present disclosure. In this example, a WDM transmission system 500 connects a plurality of networks (for example, a core network, a metropolitan network, and the like) to each other. In addition, a ROADM 1 (la to 1f) is provided in each node of the WDM transmission system 500. The ROADM 1 is an example of an optical communication device that processes a WDM signal. Therefore, the ROADM 1 can branch (or drop) an optical signal of a desired wavelength from the WDM signal. The optical signal branched from the WDM signal is guided to an access network or a device provided under the ROADM 1. In addition, the ROADM 1 can insert (or add) an optical signal transmitted from the access network or the device provided under the ROADM 1 into an unused channel of the WDM signal.

In the WDM transmission system 500 having the above configuration, for example, communication is performed between a terminal 2a and a terminal 2b. At this time, a wavelength path is established between the terminal 2a and the terminal 2b by a network management system (not illustrated). That is, control information for performing communication between the terminal 2a and the terminal 2b is configured in each ROADM 1. Note that this wavelength path is realized by a wavelength channel that propagates an optical signal having a wavelength λ1. Hereinafter, the optical signal having the wavelength λ1 may be referred to as an “optical signal λ1”.

Data to be transmitted from the terminal 2a to the terminal 2b is guided to a transponder that generates the optical signal λ1. The transponder is connected to, for example, the ROADM 1b. Then, the transponder generates the optical signal λ1 for transmitting the data. The optical signal λ1 output from the transponder is guided to the ROADM 1b. The ROADM 1b inserts the optical signal λ1 into the WDM signal. Each ROADM 1 processes the WDM signal according to the control information configured by the network management system. Specifically, the ROADM 1b guides the optical signal λ1 to the ROADM 1c, and the ROADM 1c guides the optical signal λ1 to the ROADM 1e. Then, the ROADM 1e branches the optical signal λ1 from the WDM signal and guides the optical signal λ1 to the access network. Accordingly, the terminal 2b receives the data transmitted from the terminal 2a.

When communication is performed between the terminal 2a and a terminal 2c, a wavelength path is established between the terminal 2a and the terminal 2c by the network management system. This wavelength path is realized by a wavelength channel that propagates an optical signal having a wavelength λ2. Hereinafter, the optical signal having the wavelength λ2 may be referred to as an “optical signal λ2”.

Data to be transmitted from the terminal 2a to the terminal 2c is guided to a transponder that generates the optical signal λ2. The transponder generates the optical signal λ2 for transmitting the data. The optical signal λ2 output from the transponder is guided to the ROADM 1b. The ROADM 1b inserts the optical signal λ2 into the WDM signal. Each ROADM 1 processes the WDM signal according to the control information configured by the network management system. Specifically, the ROADM 1b guides the optical signal λ2 to the ROADM 1c, the ROADM 1c guides the optical signal λ2 to the ROADM 1d, and the ROADM 1d guides the optical signal λ2 to the ROADM 1f. Then, the ROADM If branches the optical signal λ2 from the WDM signal and guides the optical signal λ2 to the access network. Accordingly, the terminal 2c receives the data transmitted from the terminal 2a.

As described above, in the WDM transmission system 500, the optical signal transmitted from the access network or the terminal is inserted into the WDM signal and transmitted through one or more ROADMs. Then, the optical signal s branched from the WDM signal by the ROADM accommodating a destination terminal.

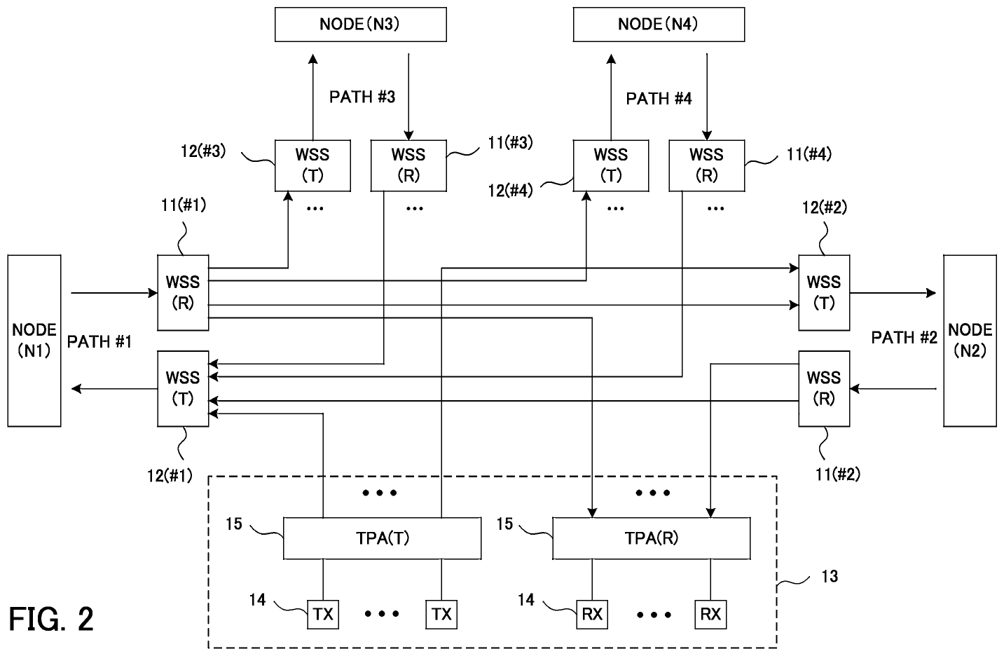

FIG. 2 illustrates an example of a configuration of the ROADM. In this example, the ROADM 1 is a four-degree ROADM. That is, the ROADM 1 can transmit WDM signals to and from four correspondent nodes (N1 to N4). In addition, the ROADM 1 includes an add/drop unit 13.

The ROADM 1 includes a set of WSS 11 and WSS 12 for each degree (#1 to #4). The WSS 11 processes a WDM signal received from a corresponding node. That is, the WSS 11 processes each optical signal in the received WDM signal according to a wavelength. For example, the WSS 11 (#1) guides each optical signal in the WDM signal received from the node N1 to the WSS 12 (#2) corresponding to the path #2, the WSS 12 (#3) corresponding to the path #3, the WSS 12 (#4) corresponding to the path #4, or the add/drop unit 13 according to the wavelength. The WSS 12 generates a WDM signal to be transmitted to a corresponding node. For example, the WSS 12 (#1) multiplexes optical signals guided from the WSS 11 (#2) corresponding to the path #2, the WSS 11 (#3) corresponding to the path #3, the WSS 11 (#4) corresponding to the path #4, and the add/drop unit 13 to generate a WDM signal.

The add/drop unit 13 includes a plurality of transponders 14 and a transponder aggregator (TPA) 15 that accommodates the plurality of transponders 14. Each transponder 14 includes an optical transmitter (TX) and an optical receiver (RX). Note that different wavelengths are preferably assigned to the plurality of transponders 14. The TPA 15 includes a WSS or a multicast switch (MCS), and can associate an arbitrary transponder 14 with an arbitrary path.

For example, when a signal addressed to the node N1 is generated by the transponder 14, the TPA 15 guides the signal to the WSS 12 (#1). When a signal is received from any of the WSSs 11, the TPA 15 guides the signal to the transponder 14 corresponding to the destination.

In this manner, the ROADM processes the WDM signal by using the WSS. On the other hand, in order to further increase capacity of optical communication, WDM transmission using an S band and/or a U band in addition to a C band/L band has been studied. In this case, the ROADM is required to include a WSS capable of processing the S, C, L, and U bands. However, it is not easy to manufacture a WSS that processes a wideband WDM signal. Alternatively, a WSS that processes a wideband WDM signal is expensive.

This problem may be solved by appropriately converting a wavelength of an optical signal using a wavelength converter in the ROADM. For example, by providing a wavelength converter that converts a wavelength of an optical signal between the S band and the C band and a wavelength converter that converts a wavelength of an optical signal between the U band and the L band, the ROADM can process a WDM signal including a S/C/L/U band by using a WSS corresponding to a C/L band.

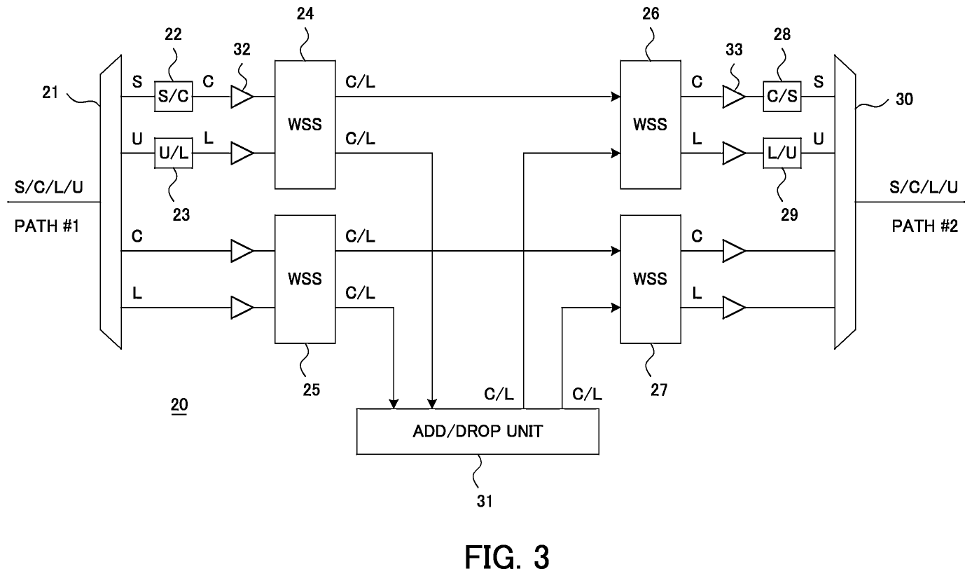

FIG. 3 illustrates an example of a ROADM including a wavelength converter for extending a wavelength region. In the example illustrated in FIG. 3, a ROADM 20 provides two degrees (#1 and #2). That is, the ROADM 20 can transmit a WDM signal to and from the node N1 via the path #1, and can transmit a WDM signal to and from the node N2 via the path #2. However, in FIG. 3, in order to make the drawing easily viewable, a circuit for transmitting a WDM signal from the node N1 to the node N2 is illustrated, and a circuit for transmitting a WDM signal from the node N2 to the node N1 is omitted.

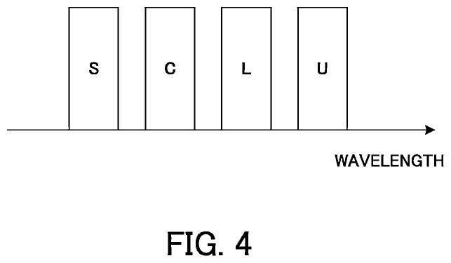

The ROADM 20 transmits a WDM signal including an S band, a C band, an L band, and a U band illustrated in FIG. 4. Note that “S”, “C”, “L”, and “U” illustrated in FIG. 3 represent the S band, the C band, the L band, and the U band, respectively. “S/C/L/U” represents a state in which the S band, the C band, the L band, and the U band are multiplexed. Similarly, “C/L” represents a state in which the C band and the L band are multiplexed.

The ROADM 20 includes a wavelength filter 21, wavelength converters 22 and 23, WSSs 24 to 27, wavelength converters 28 and 29, a multiplexer 30, and an add/drop unit 31. Note that the ROADM 20 may further include other devices, circuits, or functions not illustrated in FIG. 3.

The wavelength filter 21 separates a WDM signal arriving at the ROADM 20 via the path #1 for each wavelength band. Specifically, the wavelength filter 21 extracts an S-band WDM signal, a C-band WDM signal, an L-band WDM signal, and a U-band WDM signal from the received WDM signal.

The wavelength converter 22 performs wavelength conversion from the S band to the C band. Therefore, the wavelength converter 22 converts the S-band WDM signal extracted by the wavelength filter 21 into the C-band WDM signal. The wavelength converter 23 performs wavelength conversion from the U band to the L band. Therefore, the wavelength converter 23 converts the U-band WDM signal extracted by the wavelength filter 21 into the L-band WDM signal.

The C-band WDM signal generated by the wavelength converter 22 and the L-band WDM signal generated by the wavelength converter 23 are guided to the WSS 24. On the other hand, the C-band WDM signal and the L-band WDM signal extracted by the wavelength filter 21 are guided to the WSS 25 without being subjected to wavelength conversion.

Each of the WSS 24 and the WSS 25 processes optical signals in the input WDM signals. Specifically, the WSS 24 guides an optical signal to be transferred to the node N2 to the WSS 26, and guides an optical signal to be transmitted to the access network to the add/drop unit 31. Similarly, the WSS 25 guides an optical signal to be transmitted to the node N2 to the WSS 27, and guides an optical signal to be transmitted to the access network to the add/drop unit 31.

The add/drop unit 31 transfers the optical signals guided from the WSS 24 and the WSS 25 to a destination terminal in the access network.

The add/drop unit 31 can generate an optical signal to be transmitted to the node N2. The optical signal to be transmitted to the node N2 is guided to the WSS 26 or the WSS 27.

An optical signal to be transmitted from the ROADM 20 to the node N2 using the S band or the U band is guided from the add/drop unit 31 to the WSS 26. However, the optical signal to be transmitted to the node N2 using the S band is allocated in the C band between the add/drop unit 31 and the WSS 26. The optical signal to be transmitted to the node N2 using the U band is allocated in the L band between the add/drop unit 31 and the WSS 26. On the other hand, an optical signal to be transmitted from the ROADM 20 to the node N2 using the C band or the L band is guided from the add/drop unit 31 to the WSS 27. The optical signal to be transmitted to the node N2 using the C band is allocated in the C band between the add/drop unit 31 and the WSS 27. The optical signal to be transmitted to the node N2 using the L band is allocated in the L band between the add/drop unit 31 and the WSS 27.

The WSS 26 processes the optical signals guided from the WSS 24 and the add/drop unit 31. At this time, the optical signal allocated in the C band is guided to the wavelength converter 28, and the optical signal allocated in the L band is guided to the wavelength converter 29.

The wavelength converter 28 performs wavelength conversion from the C band to the S band. Therefore, the optical signal guided from the WSS 26 is allocated in the S band by the wavelength converter 28. The wavelength converter 29 performs wavelength conversion from the L band to the U band. Therefore, the optical signal guided from the WSS 26 is allocated in the U band by the wavelength converter 29. The optical signals output from the wavelength converter 28 and the wavelength converter 29 are guided to the multiplexer 30.

The WSS 27 processes the optical signals guided from the WSS 25 and the add/drop unit 31. At this time, the optical signals to be transmitted to the node N2 are guided to the multiplexer 30 without being subjected to wavelength conversion.

The multiplexer 30 multiplexes the S-band WDM signal output from the wavelength converter 28, the U-band WDM signal output from the wavelength converter 29, and a C/L-band WDM signal output from the WSS 27. As a result, an S/C/L/U-band WDM signal is generated. That is, the S/C/L/U-band WDM signal is transmitted from the ROADM 20 to the node N2.

Note that, as illustrated in FIG. 3, optical amplifiers 32 may be provided between the wavelength converters 22, 23 and the WSS 24 and between the wavelength filter 21 and the WSS 25. Optical amplifiers 33 may be provided between the WSS 26 and the wavelength converters 28, 29 and between the WSS 27 and the multiplexer 30. The optical amplifiers 32 and 33 amplify the WDM signals.

As described above, the ROADM 20 includes the wavelength converters (22 and 28) that perform wavelength conversion between the S band and the C band and the wavelength converters (23 and 29) that perform wavelength conversion between the U band and the L band, so that it is possible to process the S/C/L/U-band WDM signal using the WSSs corresponding to the C/L bands. That is, a bandwidth of the WDM signal that can be processed by the ROADM is extended without increasing a band of the WSS.

However, in the configuration illustrated in FIG. 3, an optical signal-to-noise ratio (OSNR) deteriorates due to addition of the wavelength converter in the ROADM. Specifically, when the optical signal in the S/U-band WDM signal passes through the wavelength converter, noise is added. Therefore, in a case where the optical signal in the S/U-band WDM signal is transmitted via a plurality of ROADMs, OSNR degradation accumulates.

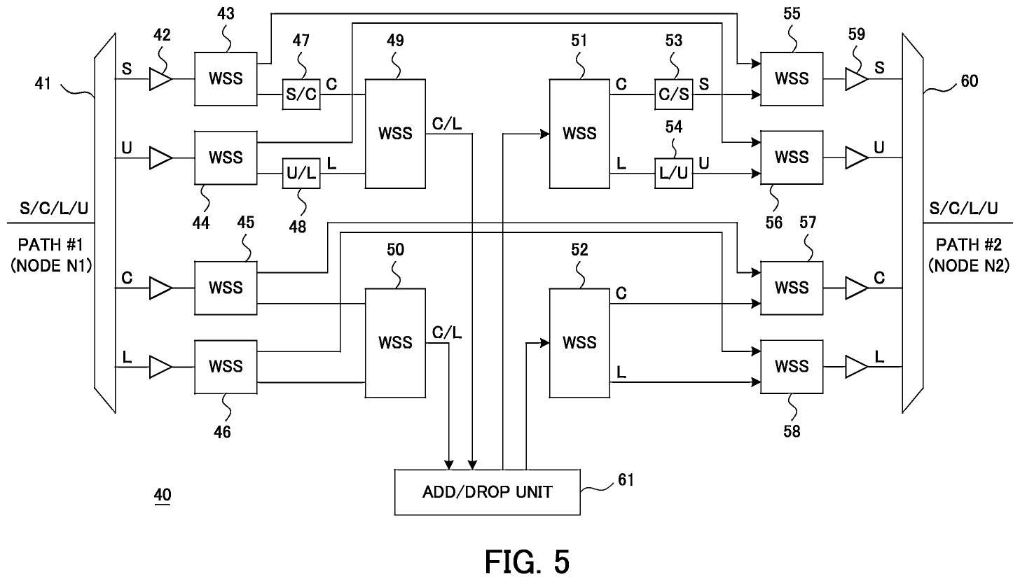

FIG. 5 illustrates another example of a ROADM including a wavelength converter for extending a wavelength region. In the example illustrated in FIG. 5, a ROADM 40 provides two degrees (#1 and #2). That is, the ROADM 40 can transmit a WDM signal to and from the node N1 via the path #1, and can transmit a WDM signal to and from the node N2 via the path #2. However, in FIG. 5, in order to make the drawing easily viewable, a circuit for transmitting a WDM signal from the node N1 to the node N2 is illustrated, and a circuit for transmitting a WDM signal from the node N2 to the node N1 is omitted. Further, similarly to the case illustrated in FIG. 3, the ROADM 40 transmits an S/C/L/U-band WDM signal including an S band, a C band, an L band, and a U band.

The ROADM 40 includes a wavelength filter 41, optical amplifiers 42, WSSs 43 to 46, wavelength converters 47 and 48, WSSs 49 to 52, wavelength converters 53 and 54, WSSs 55 to 58, optical amplifiers 59, a multiplexer 60, and an add/drop unit 61. Note that the ROADM 40 may further include other devices, circuits, or functions not illustrated in FIG. 5.

The wavelength filter 41 separates a WDM signal arriving at the ROADM 40 via the path #1 for each wavelength band. Specifically, the wavelength filter 41 extracts an S-band WDM signal, a U-band WDM signal, a C-band WDM signal, and an L-band WDM signal from the received WDM signal. The optical amplifier 42 amplifies the WDM signal of each wavelength band extracted by the wavelength filter 41.

The WSS 43 processes the S-band WDM signal extracted by the wavelength filter 41. Specifically, the WSS 43 guides an optical signal to be transferred to the node N2 to the WSS 55, and guides an optical signal to be transmitted to the access network to the wavelength converter 47. That is, the optical signal branched from the S-band WDM signal by the WSS 43 is guided to the wavelength converter 47, and the remaining optical signal not branched from the S-band WDM signal is guided to the WSS 55. Similarly, the WSS 44 processes the U-band WDM signal extracted by the wavelength filter 41. Specifically, the WSS 44 guides an optical signal to be transmitted to the node N2 to the WSS 56, and guides an optical signal to be transmitted to the access network to the wavelength converter 48. That is, the optical signal branched from the U-band WDM signal by the WSS 44 is guided to the wavelength converter 48, and the remaining optical signal not branched from the U-band WDM signal is guided to the WSS 56.

The wavelength converter 47 performs wavelength conversion from the S band to the C band. Therefore, the wavelength converter 47 allocates the optical signal in the S band guided from the WSS 43 in the C band. The wavelength converter 48 performs wavelength conversion from the U band to the L band. Therefore, the wavelength converter 48 allocates the optical signal in the U band guided from the WSS 44 in the L band.

The WSS 49 processes the optical signal output from the wavelength converter 47 and the optical signal output from the wavelength converter 48. At this time, the WSS 49 guides each optical signal to the add/drop unit 61. Here, when the add/drop unit 61 includes a plurality of transponders or a plurality of transponder aggregators (TPA), the WSS 49 can guide each optical signal to a transponder or a TPA corresponding to a wavelength.

The WSS 45 processes the C-band WDM signal extracted by the wavelength filter 41. Specifically, the WSS 45 guides an optical signal to be transmitted to the node N2 to the WSS 57, and guides an optical signal to be transmitted to the access network to the WSS 50. That is, the optical signal branched from the C-band WDM signal by the WSS 45 is guided to the WSS 50, and the remaining optical signal not branched from the C-band WDM signal is guided to the WSS 57. Similarly, the WSS 46 processes the L-band WDM signal extracted by the wavelength filter 41. Specifically, the WSS 46 guides an optical signal to be transmitted to the node N2 to the WSS 58, and guides an optical signal to be transmitted to the access network to the WSS 50. That is, the optical signal branched from the L-band WDM signal by the WSS 46 is guided to the WSS 50, and the remaining optical signal not branched from the L-band WDM signal is guided to the WSS 58.

The WSS 50 processes the optical signal in the C band output from the WSS 45 and the optical signal in the L band output from the WSS 46. At this time, the WSS 50 guides each optical signal to the add/drop unit 61. Here, when the add/drop unit 61 includes a plurality of transponders or a plurality of transponder aggregators (TPA), the WSS 50 can guide each optical signal to a transponder or a TPA corresponding to a wavelength.

The WSS 51 processes an optical signal from the add/drop unit 61 toward the node N2. At this time, the optical signal allocated in the C band is guided to the wavelength converter 53, and the optical signal allocated in the L band is guided to the wavelength converter 54.

The wavelength converter 53 performs wavelength conversion from the C band to the S band. Therefore, the optical signal guided from the WSS 51 is allocated in the S band by the wavelength converter 53. The wavelength converter 54 performs wavelength conversion from the L band to the U band. Therefore, the optical signal guided from the WSS 51 is allocated in the U band by the wavelength converter 54. The optical signals output from the wavelength converter 53 and the wavelength converter 54 are guided to the WSS 55 and the WSS 56, respectively.

The WSS 55 processes the optical signal guided from the WSS 43 and the optical signal output from the wavelength converter 53. As a result, an S-band WDM signal is generated. Similarly, the WSS 56 processes the optical signal guided from the WSS 44 and the optical signal output from the wavelength converter 54. As a result, a U-band WDM signal is generated.

The WSS 52 processes an optical signal from the add/drop unit 61 toward the node N2. At this time, the optical signal allocated in the C band is guided to the WSS 57, and the optical signal allocated in the L band is guided to the WSS 58.

The WSS 57 processes the optical signal guided from the WSS 45 and the optical signal guided from the WSS 52. As a result, a C-band WDM signal is generated. Similarly, the WSS 58 processes the optical signal guided from the WSS 46 and the optical signal output from the WSS 52. As a result, an L-band WDM signal is generated.

The multiplexer 60 multiplexes the S-band WDM signal output from the WSS 55, the U-band WDM signal output from the WSS 56, the C-band WDM signal output from the WSS 57, and the L-band WDM signal output from the WSS 58. As a result, an S/C/L/U-band WDM signal is generated. That is, the S/C/L/U-band WDM signal is transmitted from the ROADM 40 to the node N2. Note that each of the WDM signals output from the WSSs 55 to 58 is amplified by the optical amplifier 59.

The add/drop unit 61 guides the optical signals guided from the WSS 49 and the WSS 50 to the access network or a destination device provided under the ROADM 40. That is, the optical signal branched from the input WDM signal is guided by the add/drop unit 61 to the access network or the destination device provided under the ROADM 40. In addition, the add/drop unit 61 can insert an optical signal received from the access network or a transmission source device provided under the ROADM 40 into the output WDM signal. At this time, a signal to be allocated in the S band or U band between the ROADM 40 and the node N2 is guided to the WSS 51. Also, a signal to be allocated in the C band or L and between the ROADM 40 and the node N2 is guided to the WSS 52.

In this manner, the ROADM 40 can process the S/C/L/U-band WDM signal similarly to the ROADM 20 illustrated in FIG. 3. That is, also in the configuration illustrated in FIG. 5, a band of the WDM signal that can be processed by the ROADM is extended.

In addition, in the ROADM 40, the optical signal forwarded to the node N2 without being branched from the WDM signal does not pass through the wavelength converter. For example, among the optical signals included in the S-band WDM signal received from the node N1, the optical signal forwarded to the node N2 is guided to the path #2 by the WSS 43 and the WSS 55. In the following description, an optical signal forwarded to the next node without being branched from the WDM signal in the ROADM may be referred to as a “through signal”.

As described above, according to the configuration illustrated in FIG. 5, unlike the configuration illustrated in FIG. 3, the through signal does not pass through the wavelength converter. Therefore, according to the configuration illustrated in FIG. 5, noise added to the through signal is suppressed as compared with the configuration illustrated in FIG. 3.

However, in the configuration illustrated in FIG. 5, the number of WSSs implemented in the ROADM increases. For example, when focusing on the S band, in the configuration illustrated in FIG. 3, one WSS (for example, the WSS 24) is implemented for the input path, and one WSS (for example, the WSS 26) is implemented for the output path. On the other hand, in the configuration illustrated in FIG. 5, two WSSs (for example, the WSS 43 and the WSS 49) are implemented for the input path, and two WSSs (for example, the WSS 51 and the WSS 55) are implemented for the output path. Here, the WSS is generally expensive. Therefore, in the configuration illustrated in FIG. 5, the cost for manufacturing the ROADM increases.

### EMBODIMENTS

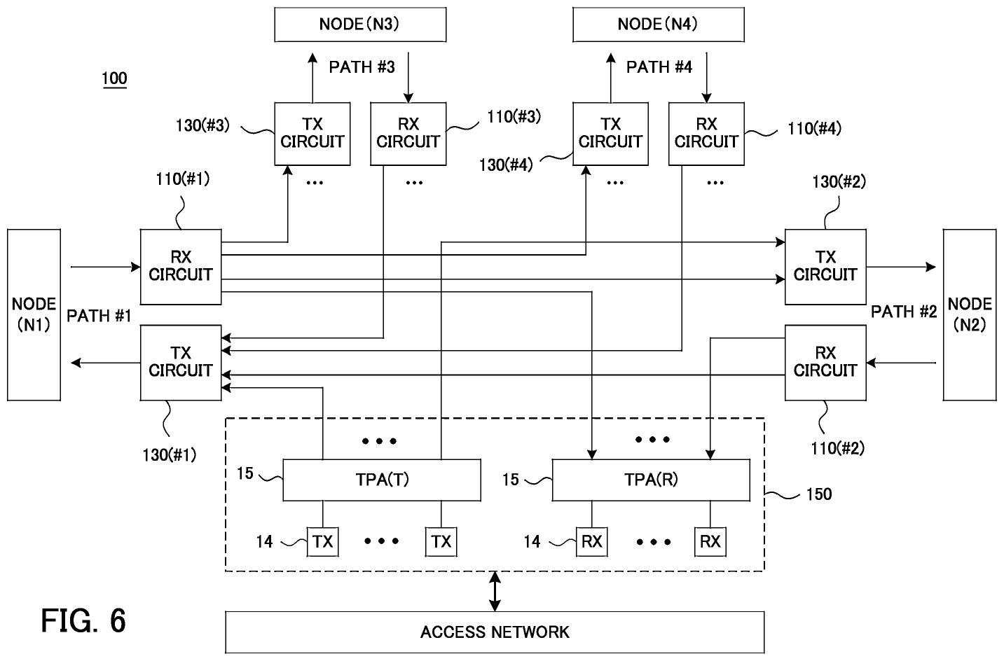

FIG. 6 illustrates an example of a configuration of a ROADM according to an embodiment of the present disclosure. A ROADM 100 according to the embodiment is provided in each node of a WDM transmission system (for example, the WDM transmission system 500 illustrated in FIG. 1). In this example, the ROADM 100 is a four-degree ROADM. That is, the ROADM 100 can transmit WDM signals to and from four nodes (N1 to N4).

The ROADM 100 includes a set of a reception circuit 110 and a transmission circuit 130 for each path (#1 to #4). The reception circuit 110 processes a WDM signal received from a corresponding node. That is, the reception circuit 110 processes each optical signal in the received WDM signal according to a wavelength. For example, the reception circuit 110 (#1) guides each optical signal in the WDM signal received from the node N1 to the transmission circuit 130 (#2) corresponding to the path #2, the transmission circuit 130 (#3) corresponding to the path #3, the transmission circuit 130 (#4) corresponding to the path #4, or an add/drop unit 150 according to the wavelength. The transmission circuit 130 generates a WDM signal to be transmitted to a corresponding node. For example, the transmission circuit 130 (#1) multiplexes optical signals guided from the reception circuit 110 (#2) corresponding to the path #2, the reception circuit 110 (#3) corresponding to the path #3, the reception circuit 110 (#4) corresponding to the path #4, and the add/drop unit 150 to generate a WDM signal.

The add/drop unit 150 includes a plurality of transponders 14 and a transponder aggregator (TPA) 15 that accommodates the plurality of transponders 14. The add/drop unit 150 is connected to the access network. Note that a configuration and an operation of the add/drop unit 150 are substantially the same as those of the add/drop unit 13 illustrated in FIG. 2, and description thereof will be omitted.

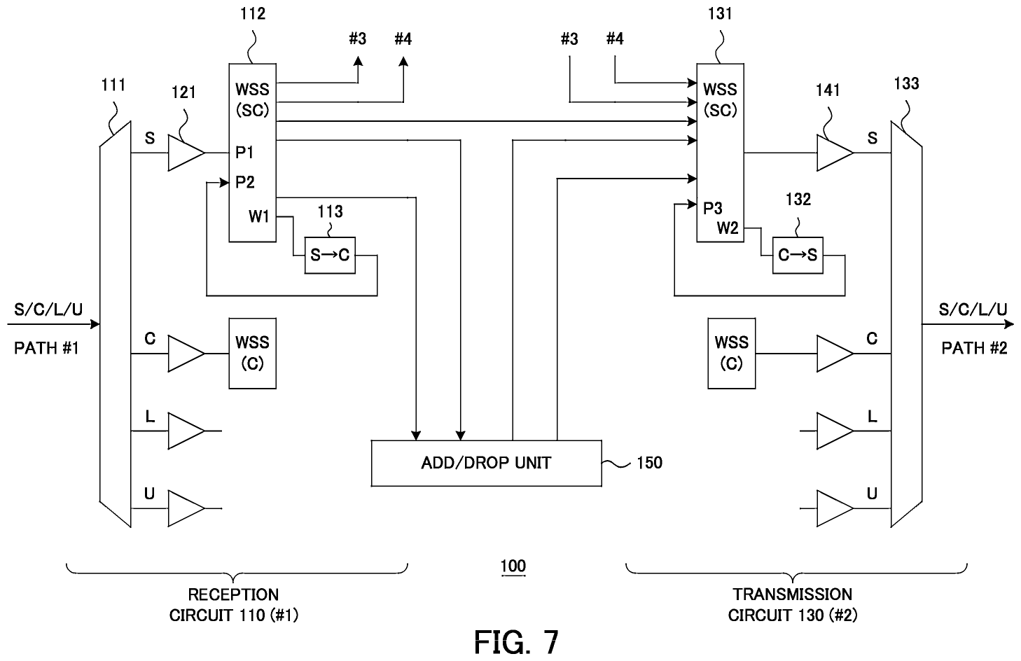

FIG. 7 illustrates an example of the reception circuit and the transmission circuit implemented 1n the ROADM 100 according to the embodiment of the present disclosure. Note that the ROADM 100 illustrated in FIG. 7 is a part of the ROADM 100 illustrated in FIG. 6. Specifically, FIG. 7 illustrates the reception circuit 110 (#1), the transmission circuit 130 (#2), and the add/drop unit 150 illustrated in FIG. 6.

The reception circuit 110 includes a WDM filter 111, a WSS 112, and a wavelength converter 113. However, the reception circuit 110 may further include other devices not illustrated in FIG. 7. For example, the reception circuit 110 may include an optical amplifier that amplifies an optical signal.

The reception circuit 110 receives a WDM signal transmitted from another node. In the example illustrated in FIG. 7, the reception circuit 110 (#1) receives the WDM signal transmitted from the node N1 illustrated in FIG. 6 via the path #1. The WDM signal includes a WDM signal allocated in an S band (hereinafter, an S-band WDM signal), a WDM signal allocated in a C band (hereinafter, a C-band WDM signal), a WDM signal allocated in an L band (hereinafter, an L-band WDM signal), and a WDM signal allocated in a U band (hereinafter, a U-band WDM signal).

The WDM filter 111 extracts the S-band WDM signal, the C-band WDM signal, the L-band WDM signal, and the U-band WDM signal from input light. Here, each WDM signal extracted by the WDM filter 111 is preferably amplified by an optical amplifier 121 as illustrated in FIG. 7. Note that, in the following description, a configuration for processing the S-band WDM signal will be described. The S-band WDM signal includes a plurality of optical signals having different wavelengths allocated in the S band.

As illustrated in FIG. 7, the WSS 112 includes an input port P1, an input port P2, and a plurality of output ports. The WSS 112 can then guide an optical signal input via the input port P1 or the input port P2 to a designated output port. Note that an optical path in the WSS 112 is configured for each wavelength. Each optical path is preconfigured according to a destination of the optical signal. In addition, the WSS 112 can process an optical signal allocated in the S band and an optical signal allocated in the C band.

One of the plurality of output ports is optically coupled to the wavelength converter 113. In the following description, the output port optically coupled to the wavelength converter 113 may be referred to as a “wavelength conversion port W1”.

The S-band WDM signal extracted by the WDM filter 111 is guided to the input port P1. The WSS 112 processes the plurality of optical signals included in the S-band WDM signal according to the preconfigured optical path. Specifically, the WSS 112 guides, to the wavelength conversion port W1, one or more optical signals to be branched from the S-band WDM signal and to be transmitted to the access network among the plurality of optical signals included in the S-band WDM signal. Then, the optical signal output via the wavelength conversion port W1 is guided to the wavelength converter 113.

The wavelength converter 113 performs wavelength conversion from the S band to the C band on the optical signal output via the wavelength conversion port W1 to generate a wavelength-converted optical signal. The wavelength-converted optical signal includes one or more optical signals to be transmitted to the access network. The wavelength-converted optical signal is guided to the input port P2 of the WSS 112. The reception circuit 110 may include an optical amplifier that amplifies an optical signal in the C band between the wavelength converter 113 and the input port P2. The wavelength converter 113 is implemented by, for example, periodically poled lithium niobate (PPLN). Alternatively, the wavelength converter 113 is realized by a nonlinear optical medium and a light source that generates pump light. The same applies to a wavelength converter 132 described later.

Note that the wavelength converter 113 is a part of an optical circuit optically coupled to the WSS 112. In this case, the optical circuit includes a configuration that guides the optical signal output from the WSS 112 to the transmission circuit 130 and the add/drop unit 150.

The WSS 112 guides, to a corresponding output port, an optical signal to be transmitted to another node among the plurality of optical signals input via the input port P1 (that is, the S-band WDM signal) according to the preconfigured optical path. In addition, the WSS 112 guides the optical signal input via the input port P2 (that is, one or a plurality of optical signals in the wavelength-converted optical signal) to the corresponding output port.

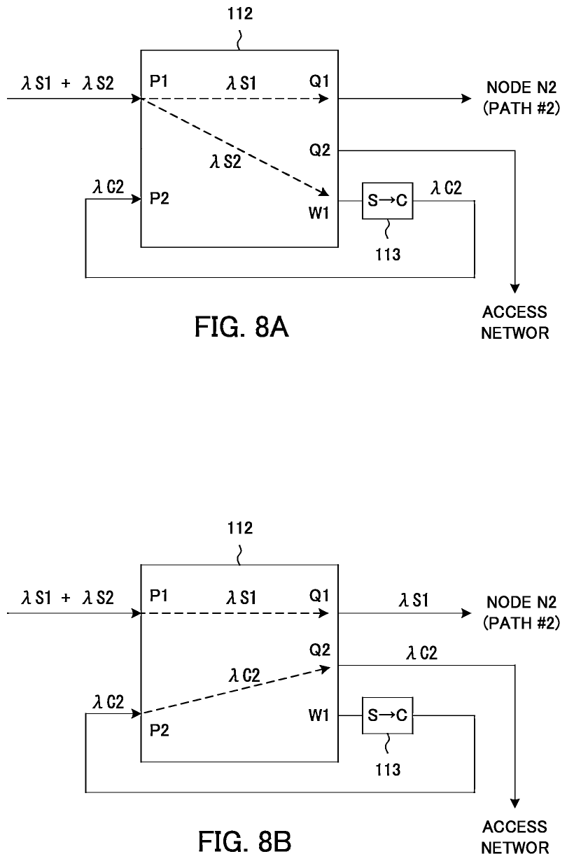

FIGS. 8A and 8B illustrate an example of an operation of the reception circuit 110. In this example, the S-band WDM signal includes an optical signal λS1 and an optical signal λS2. A destination of the optical signal λS1 is the node N2. A destination of the optical signal λS2 is a terminal in the access network. Note that the WSS 112 includes the input port P1, the input port P2, an output port Q1, an output port Q2, and the wavelength conversion port W1. Output light of the output port Q1 is guided to the transmission circuit 130 (#2) illustrated in FIG. 6 or 7. Output light of the output port Q2 is guided to the add/drop unit 150 illustrated in FIG. 6 or 7.

The optical signal λS1 and the optical signal λS2 are guided to the input port P1 as illustrated in FIG. 8A. Here, the destination of the optical signal λS1 is another node (the node N2 in this example), and the optical signal λS1 is guided to the output port Q1. In contrast, the destination of the optical signal λS2 is the access network, and the optical signal λS2 is guided to the wavelength conversion port W1. The optical signal λS2 output from the wavelength conversion port W1 is guided to the wavelength converter 113. The wavelength converter 113 performs wavelength conversion from the S band to the C band on the optical signal λS2 to generate a wavelength-converted optical signal λC2. Then, the wavelength-converted optical signal λC2 is guided to the input port P2.

As illustrated in FIG. 8B, the WSS 112 guides the wavelength-converted optical signal λC2 to the output port Q2. Therefore, the wavelength-converted optical signal λC2 is transmitted to the access network by the add/drop unit 150. On the other hand, the optical signal λS1 is transmitted to the node N2 by the transmission circuit 130.

In this manner, the optical signal λS1 is forwarded to the other node without passing through the wavelength converter. That is, the optical signal forwarded to the other node without being branched in the ROADM 100 does not pass through the wavelength converter. Therefore, quality of the through signal is good. In addition, the optical signal λS2 is converted into the C-band optical signal and transmitted to the access network. That is, the optical signal branched from the S-band WDM signal in the ROADM 100 is converted into the C-band optical signal and transmitted to the access network. Therefore, even in a case where the optical signal is transmitted from another node using the S band, the destination terminal can receive the optical signal using a widely used optical device for the C band.

As illustrated in FIG. 7, the transmission circuit 130 includes a WSS 131, the wavelength converter 132, and a multiplexer 133. However, the transmission circuit 130 may further include other devices not illustrated in FIG. 7. For example, the transmission circuit 130 may include an optical amplifier that amplifies an optical signal.

As illustrated in FIG. 7, the WSS 131 includes a plurality of input ports, a common output port, and a wavelength conversion port W2. S-band WDM signals received from other nodes are respectively guided to the corresponding input ports via the corresponding reception circuits 110. In this example, the S-band WDM signals received from the nodes N1, N3, and N4 are respectively guided to the corresponding input ports. These optical signals are guided to the common output port of the WSS 131. In addition, optical signals received from the access network are guided to the corresponding input ports via the add/drop unit 150. The optical signals received from the access network are allocated in the C band in this example. Then, the optical signals received from the access network are guided to the wavelength conversion port W2. The wavelength conversion port W2 is optically coupled to the wavelength converter 132.

An optical path in the WSS 131 is configured for each wavelength. It is assumed that each optical path is preconfigured according to a destination of the optical signal. In addition, it is assumed that the WSS 131 can process an optical signal allocated in the S band and an optical signal allocated in the C band.

The wavelength converter 132 performs wavelength conversion from the C band to the S band on the optical signal output via the wavelength conversion port W2 to generate a wavelength-converted optical signal. The wavelength-converted optical signal includes the optical signal transmitted from the access network. Then, the wavelength-converted optical signal is guided to an input port P3 of the WSS 131, and is further guided from the input port P3 to the common output port. Note that the transmission circuit 130 may include an optical amplifier that amplifies light in the S band between the wavelength converter 132 and the input port P3. Further, the input port P3 is any one of the plurality of input ports.

The plurality of optical signals output through the common output port of the WSS 131 is allocated in the S band. That is, the plurality of optical signals output via the common output port of the WSS 131 forms an S-band WDM signal. Then, the S-band WDM signal is guided to the multiplexer 133. A C-band WDM signal, an L-band WDM signal, and a U-band WDM signal are also input to the multiplexer 133. Here, as illustrated in FIG. 7, these WDM signals are preferably amplified by corresponding optical amplifiers 141. The multiplexer 133 multiplexes and outputs these WDM signals. In this example, the WDM signal output from the multiplexer 133 is transmitted to the node N2.

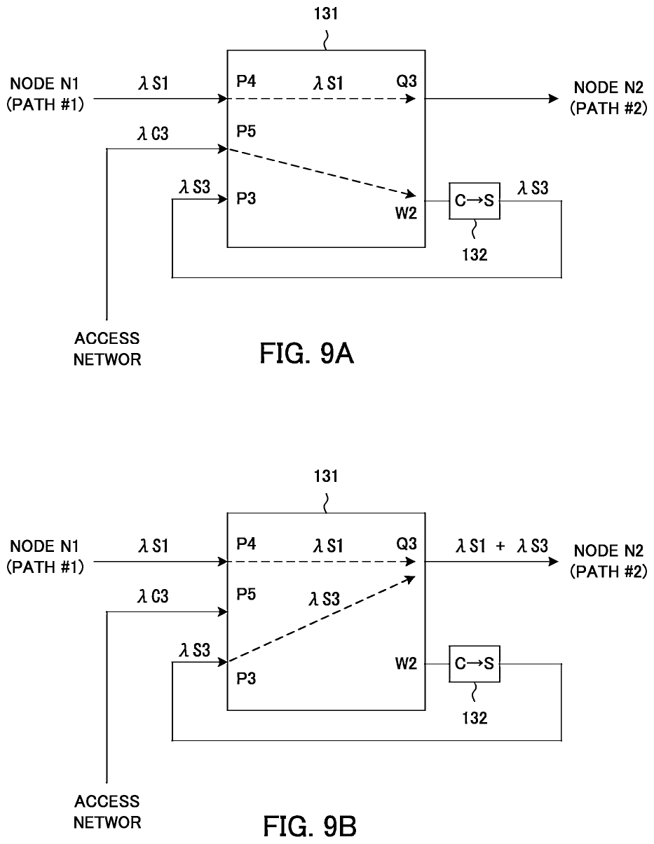

FIGS. 9A and 9B illustrate an example of an operation of the transmission circuit 130. In this example, the optical signal λS1 is transmitted from the node N1 and guided to the transmission circuit 130 by the WSS 112 illustrated in FIG. 8A or 8B. An optical signal λC3 is transmitted from the access network and guided to the transmission circuit 130 by the add/drop unit 150. The optical signal λS1 is allocated in the S band, and the optical signal λC3 is allocated in the C band. The WSS 131 includes input ports P3 to P5, a common output port Q3, and the wavelength conversion port W2.

As illustrated in FIG. 9A, the optical signal λS1 arrives at the input port P4. The WSS 131 guides the optical signal λS1 from the input port P4 to the common output port Q3. The optical signal λC3 received from the access network is guided to the input port P5. The WSS 131 guides the optical signal λC3 from the input port P5 to the wavelength conversion port W2. The optical signal λC3 output from the wavelength conversion port W2 is guided to the wavelength converter 132. The wavelength converter 132 performs wavelength conversion from the C band to the S band on the optical signal λC3 to generate a wavelength-converted optical signal λS3. The wavelength-converted optical signal λS3 is guided to the input port P3.

As illustrated in FIG. 9B, the WSS 131 guides the wavelength-converted optical signal λS3 to the common output port Q3. Therefore, the WSS 131 outputs the optical signal λS1 and the optical signal λS3 via the common output port Q3. The optical signal λS1 and the optical signal λS3 are multiplexed with the C-band WDM signal, the L-band WDM signal, and the U-band WDM signal in the multiplexer 133 and transmitted to the node N2.

As described above, also in the transmission circuit 130, the optical signal λS1 allocated in the S band is forwarded to another node without passing through the wavelength converter. That is, the optical signal forwarded to the other node without being branched in the ROADM 100 does not pass through the wavelength converter in both the reception circuit 110 and the transmission circuit 130. Therefore, quality of the through signal allocated in the S band is good. In addition, the optical signal λC3 received from the access network is converted into the S-band optical signal and forwarded to the other node.

Note that, in the example illustrated in FIGS. 7 to 9B, the WDM signal allocated in the S band is processed, but the ROADM 100 according to the embodiment can also process a WDM signal allocated in a U band. However, in a case where the WDM signal allocated in the U band is processed, the reception circuit 110 includes a wavelength converter that performs wavelength conversion from the U band to the L band, and the transmission circuit 130 includes a wavelength converter that performs wavelength conversion from the L band to the U band.

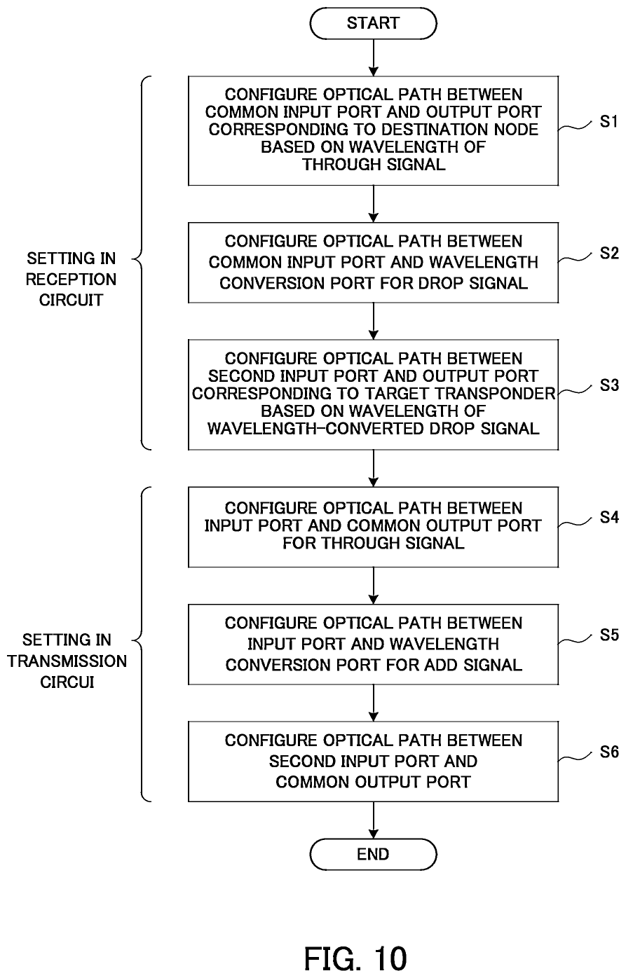

FIG. 10 is a flowchart illustrating an example of a procedure for setting a WSS in the ROADM 100. In this example, a procedure for configuring an optical path in the WSS (the WSS 112 and the WSS 131 in FIG. 7) that processes a WDM signal allocated in a S band will be described. The optical path in the WSS is configured by, for example, a network administrator. In this case, the network administrator configures the optical path between a desired input port and a desired output port, for example, by controlling an angle of a mirror implemented in the WSS.

In S1 to S3, the WSS 112 implemented in the reception circuit 110 is configured. S1 to S2 relate to setting of the S band, and S3 relates to setting of a C band.

In S1, the network administrator configures an optical path between a common input port and an output port corresponding to a destination node based on a wavelength of each through signal in a received WDM signal. The through signal represents an optical signal to be forwarded to another node without being branched from the received WDM signal. The common input port is an optical port at which the received WDM signal arrives, and corresponds to the port P1 in the example illustrated in FIG. 8A or 8B.

In S2, the network administrator configures an optical path between the common input port and a wavelength conversion port for a drop signal. The drop signal represents an optical signal branched from the received WDM signal and guided to the access network. The wavelength conversion port is an optical port optically coupled to the wavelength converter 113 and corresponds to the wavelength conversion port W1 illustrated in FIG. 8A or 8B.

In S3, the network administrator configures an optical path between a second input port and an output port corresponding to a target transponder based on a wavelength of each wavelength-converted drop signal. The second input port is an optical port to which output light of the wavelength converter 113 is guided, and corresponds to the input port P2 illustrated in FIG. 8A or 8B.

In S4 to S6, the WSS 131 implemented in the transmission circuit 130 is configured. S4 and S6 relate to setting of the S band, and S5 relates to setting of the C band.

In S4, the network administrator configures an optical path between an input port and a common output port for the through signal. The common output port is an optical port from which the transmission WDM signal is output, and corresponds to the output port Q3 illustrated in FIG. 9A or 9B.

In S5, the network administrator configures an optical path between an input port and a wavelength conversion port for an add signal. The add signal is an optical signal that is received from the access network and to be inserted into the transmission WDM signal. The wavelength conversion port is an optical port optically coupled to the wavelength converter 132 and corresponds to the wavelength conversion port W2 illustrated in FIG. 9A or 9B.

In S6, the network administrator configures an optical path between a second input port and the common output port. The second input port is an optical port to which output light of the wavelength converter 132 is guided, and corresponds to the input port P3 illustrated in FIG. 9A or 9B.

Note that the procedure illustrated in FIG. 10 is an example, and the order of executing steps is not particularly limited. For example, the transmission circuit may be configured before the setting of the reception circuit. In addition, the steps may be executed in parallel.

### Effects of Embodiment

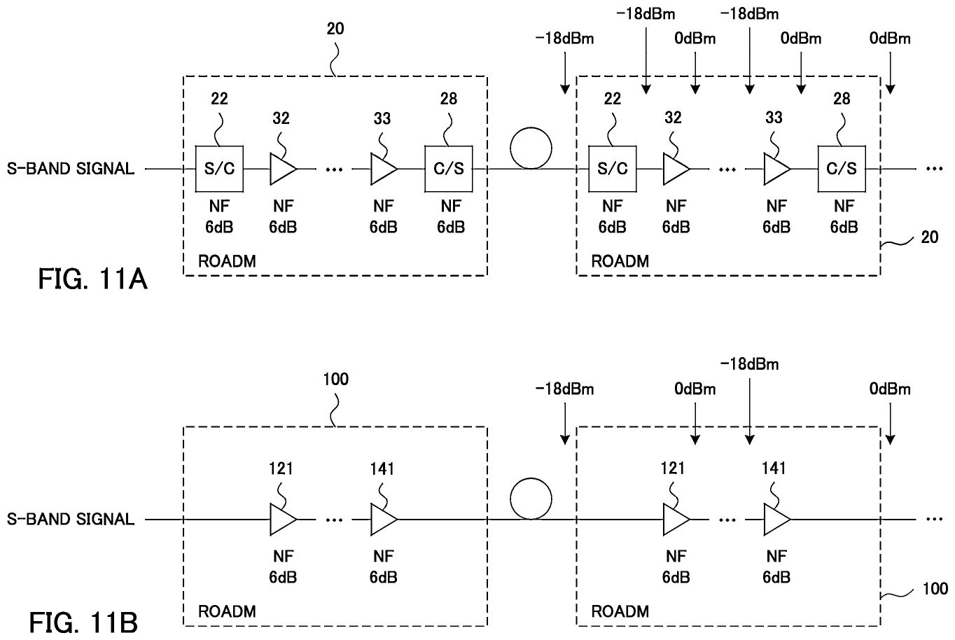

FIGS. 11A and 11B each illustrate an example of a level and a noise figure of an optical signal transmitted by the ROADM. FIG. 11A illustrates an example of a level and a noise figure of an optical signal transmitted by the ROADM 20 illustrated in FIG. 3. FIG. 11B illustrates an example of a level and a noise figure of an optical signal transmitted by the ROADM 100 according to the embodiment. Note that it is assumed that an arbitrary optical signal in an S-band WDM signal is transmitted.

In this example, an input optical level of the ROADM (20, 100) is −18 dBm. A gain of the optical amplifier (32, 33, 121, 141) is 18 dB. A conversion efficiency of the wavelength converter (22, 28) is 0 dB. A noise figure (NF) of the optical amplifier is 6 dB. A noise figure of the wavelength converter is 6 dB. A loss for a through signal in the ROADM is 18 dB.

When an optical signal is transmitted via the plurality of ROADMs, an OSNR at each node (that is, each ROADM) is expressed by Formula (1). Pin represents input optical power of the ROADM. NF represents a noise figure illustrated in FIG. 11A or FIG. 11B. h represents Planck's constant. ν represents a frequency of light. Δf represents a bandwidth when a noise figure is measured.

$$O S N R = \frac{{P}_{i n}}{N F h v Δ f} \qquad ( 1 )$$

When the optical signal is transmitted through the plurality of ROADMs, OSNR_RX at a reception node is expressed by Formula (2). Note that OSNRi represents an OSNR at each node and is calculated in (1) described above.

$$OSNR\_RX = \frac{1}{\sum ( 1 / OSNRi )} \qquad ( 2 )$$

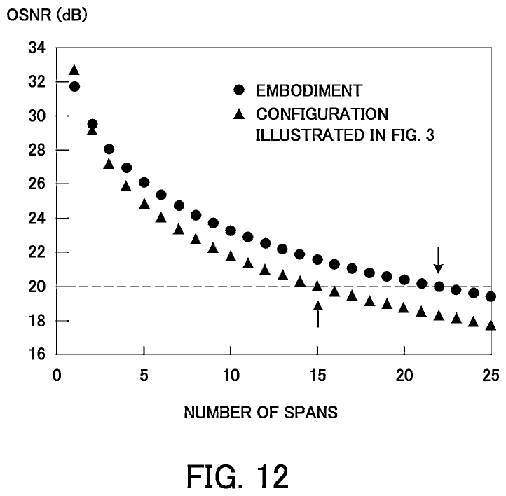

FIG. 12 illustrates an effect according to the embodiment. The horizontal axis represents the number of spans a of path through which an optical signal is transmitted. That is, the horizontal axis represents the number of ROADMs provided between a transmission node and a reception node. The vertical axis represents an OSNR at the reception node and is calculated by the above Formula (2). A triangular symbol represents an OSNR in a WDM transmission system in which the ROADM 20 illustrated in FIG. 3 is provided in each node. The OSNR is calculated based on a model illustrated in FIG. 11A. A circular symbol represents an OSNR in a WDM transmission system in which the ROADM 100 according to the embodiment is provided in each node. The OSNR is calculated based on a model illustrated in FIG. 11B.

In either case, a reception OSNR deteriorates as the number of spans increases. However, as compared with the configuration illustrated in FIG. 3, deterioration of the reception OSNR is suppressed according to the embodiment. That is, compared with the configuration illustrated in FIG. 3, the reception OSNR is improved according to the embodiment. As a result, by providing the ROADM according to the embodiment, the number of spans capable of transmitting optical signals increases. For example, it is assumed that a reception OSNR of 20 dB is required in order to realize high-quality optical communication. In this case, transmission of 15 spans is possible in the configuration illustrated in FIG. 3, but transmission of 22 spans is possible according to the embodiment.

Note that, also in the configuration illustrated in FIG. 5, the wavelength conversion is not performed in the ROADM for the optical signal passing through the node (that is, the through signal). Therefore, the number of spans capable of transmitting the optical signals is substantially the same in the configuration illustrated in FIG. 5 and the configuration according to the embodiment illustrated in FIGS. 6 to 7. However, in the configuration illustrated in FIG. 5, two WSSs (for example, the WSS 43 and the WSS 49) are implemented for the input path, and two WSSs (for example, the WSS 51 and the WSS 55) are implemented for the output path. On the other hand, according to the embodiment, as illustrated in FIG. 7, one WSS (for example, the WSS 112) is implemented for the input path, and one WSS (for example, the WSS 131) is implemented for the output path. Here, the WSS is generally expensive. Therefore, according to the embodiment, the cost for manufacturing the ROADM can be reduced.

### Second Embodiment

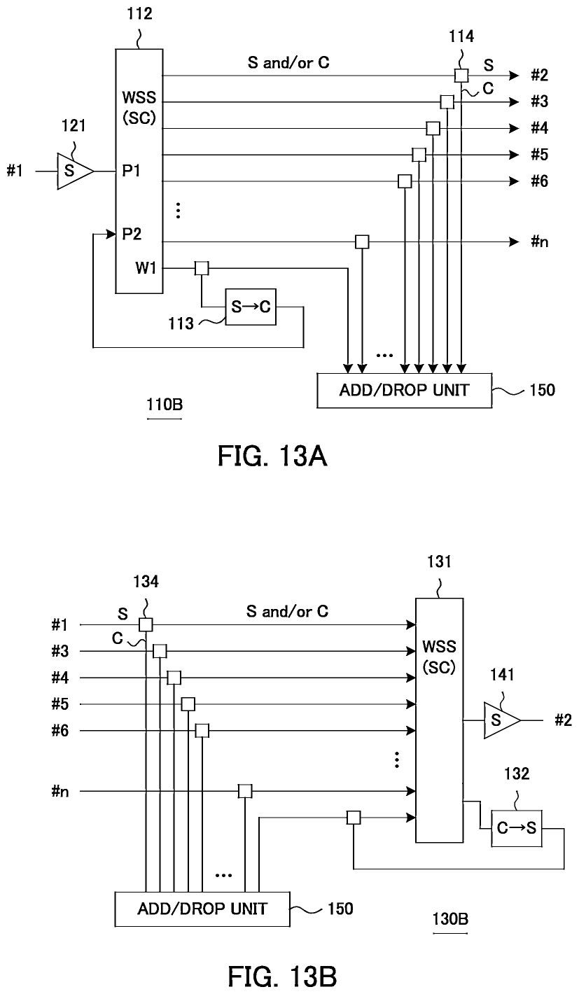

FIGS. 13A and 13B illustrate an example of a reception circuit and a transmission circuit implemented in a ROADM according to a second embodiment. The ROADM has paths 1 to n. FIG. 13A illustrates an example of a reception circuit 110B, and FIG. 13B illustrates an example of a transmission circuit 130B.

The reception circuit 110B includes the WSS 112 and the wavelength converter 113 similarly to the reception circuit 110 illustrated in FIG. 7. In addition, in the reception circuit 110B, a wavelength filter 114 is coupled to each output port of the WSS 112. The wavelength filter 114 extracts an optical signal in an S band and an optical signal in a C band. The optical signal in the S band extracted by the wavelength filter 114 is guided to the transmission circuit 130B corresponding to a destination node. In addition, the optical signal in the C band extracted by the wavelength filter 114 is guided to the add/drop unit 150.

Note that the wavelength converter 113 and the wavelength filter 114 are part of an optical circuit optically coupled to the WSS 112. In this case, the optical circuit includes a configuration that guides the optical signal output from the WSS 112 to the transmission circuit 130B and the add/drop unit 150.

The transmission circuit 130B includes the WSS 131 and the wavelength converter 132 similarly to the transmission circuit 130 illustrated in FIG. 7. In addition, in the transmission circuit 130B, a multiplexer 134 is coupled to each input port of the WSS 131. The multiplexer 134 can multiplex the optical signal in the S band and the optical signal in the C band. Specifically, the multiplexer 134 can multiplex the optical signal in the S band output from the corresponding reception circuit 110B and the optical signal in the C band output from the access network. Note that, when the optical signal in the S band is input, the WSS 131 guides the optical signal to the common output port, and when the optical signal in the C band is input, the WSS 131 guides the optical signal to the wavelength conversion port W2.

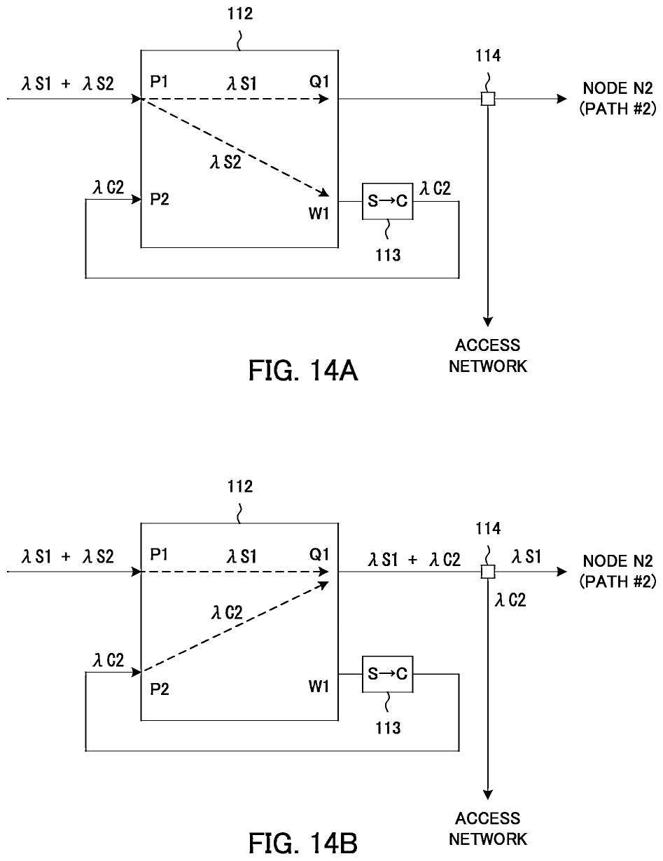

FIGS. 14A and 14B illustrate an example of an operation of the reception circuit 110B in the second embodiment. In this example, similarly to the case illustrated in FIGS. 8A and 8B, the optical signal λS1 and the optical signal λS2 arrive at the input port P1. A destination of the optical signal λS1 is the node N2, and a destination of the optical signal λS2 is a terminal in the access network. Note that the wavelength filter 114 is optically coupled to the output port Q1.

The operation illustrated in FIG. 14A is substantially the same as the operation illustrated in FIG. 9A. That is, the optical signal λS1 is guided to the output port Q1. The optical signal λS2 is converted into the optical signal λC2 by the wavelength converter 113 and guided to the input port P2.

As illustrated in FIG. 14B, the WSS 112 guides the optical signal λC2 from the input port P2 to the output port Q1. Therefore, the WSS 112 outputs the optical signal λS1 and the optical signal λC2 via the output port Q1. Then, the wavelength filter 114 extracts the optical signal λS1 and the optical signal λC2 from output light of the WSS 112. The extracted optical signal λS1 is transmitted to the destination node by the transmission circuit 130B. The extracted optical signal λC2 is transmitted to the access network by the add/drop unit 150.

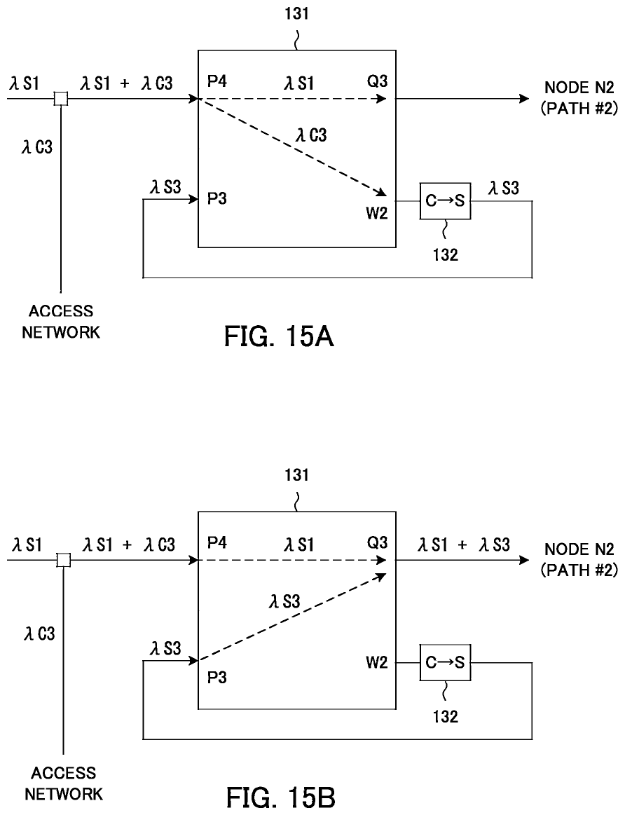

FIGS. 15A and 15B illustrate an example of an operation of the transmission circuit 130B in the second embodiment. In this example, the optical signal λS1 and the optical signal λC3 are input to the WSS 131, similarly to the case illustrated in FIGS. 9A and 9B. However, as illustrated in FIG. 15A, the optical signal λS1 and the optical signal λC3 are multiplexed by the multiplexer 134 and guided to the input port P4. Here, since the optical signal λS1 is allocated in the S band, the optical signal λS1 is guided to the output port Q3. On the other hand, since the optical signal λC3 is allocated in the C band, the optical signal λC3 is guided to the wavelength conversion port W2. Then, the optical signal λC3 is converted into an optical signal λS3 by the wavelength converter 132 and guided to the input port P3. Thereafter, the WSS 131 guides the optical signal λS3 to the output port Q3. Therefore, the optical signal λS1 and the optical signal λS3 are output via the output port Q3.

As such, in the second embodiment, the output port of the WSS implemented in the reception circuit can be shared to output a through signal and a drop signal. The through signal represents an optical signal that passes through the ROADM without being branched from the WDM signal. The drop signal represents an optical signal branched from the WDM signal and guided to the access network. In addition, the input port of the WSS implemented in the transmission circuit can be shared to input the through signal and an add signal. The add signal represents an optical signal to be inserted into the WDM signal. Therefore, in a case where the numbers of ports of the WSSs are mutually the same and the numbers of transponders connected to the access network are mutually the same, the configuration according to the second embodiment can be connected to more nodes than the configuration illustrated in FIG. 7. Therefore, the configuration of the second embodiment is effective, for example, when the number of degrees of ROADM is large.

In addition, according to this configuration, all the output ports of the WSS implemented in the reception circuit can be used as drop ports, and all the input ports of the WSS implemented in the transmission circuit can be used as add ports. Therefore, it is possible to increase the number of transponders for connecting to the access network without increasing the number of ports of the WSS. That is, it is possible to increase an add/drop ratio.

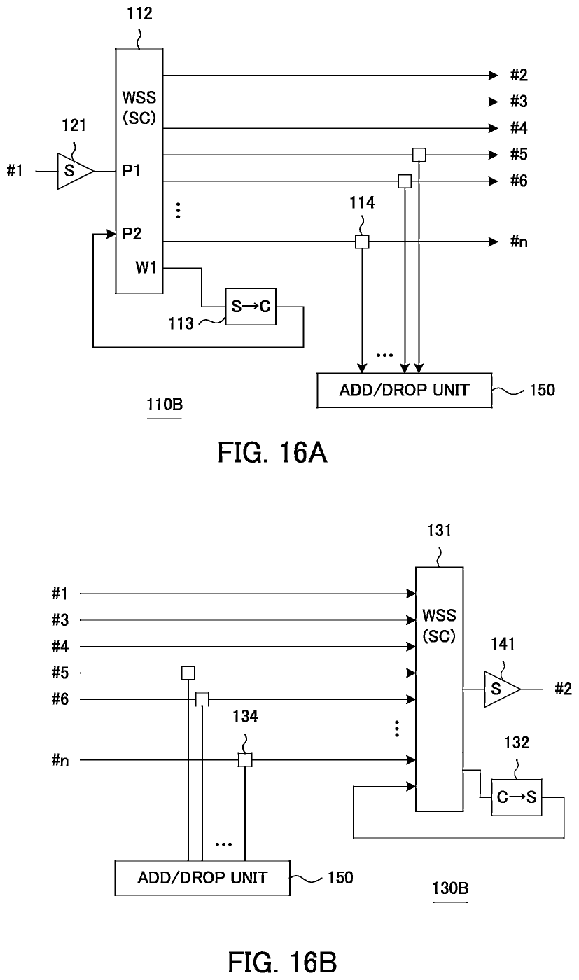

Note that, in the embodiment illustrated in FIGS. 13A and 13B, the wavelength filter 114 is provided for all the output ports of the WSS implemented in the reception circuit, and the multiplexer 134 is provided for all the input ports of the WSS implemented in the transmission circuit. However, the second embodiment is not limited to this configuration. That is, as illustrated in FIG. 16A, the reception circuit 110B may have a configuration in which the wavelength filter 114 is provided for some of the plurality of output ports included in the WSS. In addition, as illustrated in FIG. 16B, the transmission circuit 130B may have a configuration in which the multiplexer 134 is provided for some of the plurality of input ports included in the WSS.

### Third Embodiment

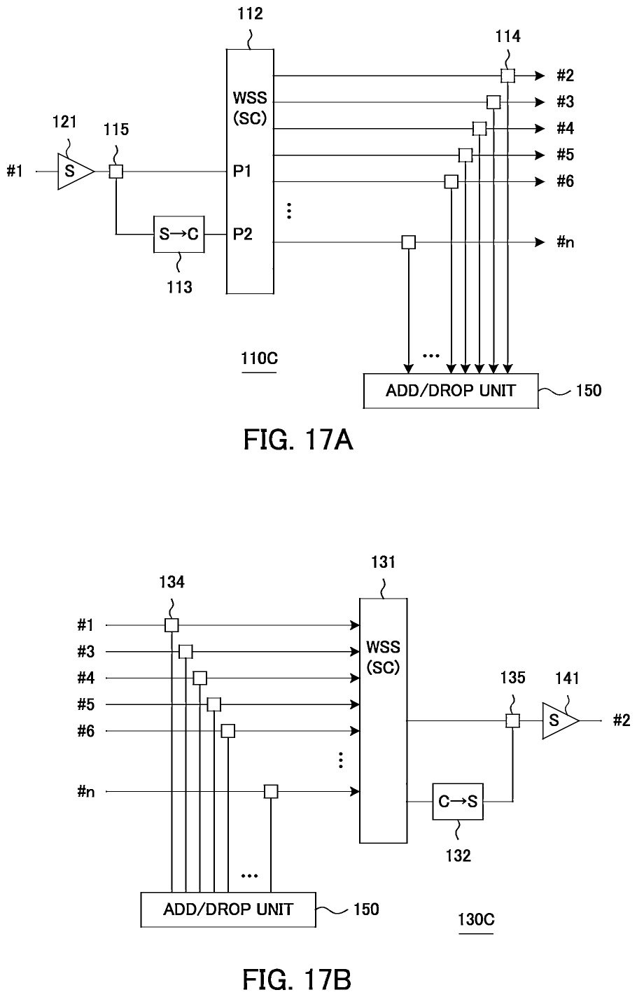

FIGS. 17A and 17B illustrate an example of a reception circuit and a transmission circuit implemented in a ROADM according to a third embodiment. The ROADM has paths 1 to n. FIG. 17A illustrates an example of a reception circuit 110C, and FIG. 17B illustrates an example of a transmission circuit 130C.

The reception circuit 110C includes the WSS 112 and the wavelength converter 113 similarly to the reception circuit 110 illustrated in FIG. 7. However, in the reception circuit 110C, the wavelength converter 113 is provided on an input side of the WSS 112. Specifically, the S-band WDM signal extracted by the WDM filter 111 is guided to the input port P1 of the WSS 112 and is also guided to the wavelength converter 113 by being branched by an optical splitter 115. The wavelength converter 113 performs wavelength conversion from the S band to the C band on an input optical signal. Then, the wavelength-converted optical signal is guided to the input port P2 of the WSS 112.

The WSS 112 guides an optical signal to be transmitted to another node among the optical signals arriving at the input port P1 to an output port corresponding to a destination node. In addition, the WSS 112 guides an optical signal to be transmitted to the access network among the optical signals arriving at the input port P2 to an output port corresponding to a destination.

The transmission circuit 130C includes the WSS 131 and the wavelength converter 132 similarly to the transmission circuit 130 illustrated in FIG. 7. However, in the transmission circuit 130C, as illustrated in FIG. 17B, a wavelength-converted optical signal generated by the wavelength converter 132 is not re-input to the WSS 131. Then, a combiner 135 combines the optical signal output from the WSS 131 and the wavelength-converted optical signal output from the wavelength converter 132.

Note that, in the example illustrated in FIG. 17A, the reception circuit 110C includes the wavelength filter 114, but the third embodiment is not limited to this configuration. That is, the reception circuit 110C may not include the wavelength filter 114. Similarly, in the example illustrated in FIG. 17B, the transmission circuit 130C includes the multiplexer 134, but the third embodiment is not limited to this configuration. That is, the transmission circuit 130C may not include the multiplexer 134.

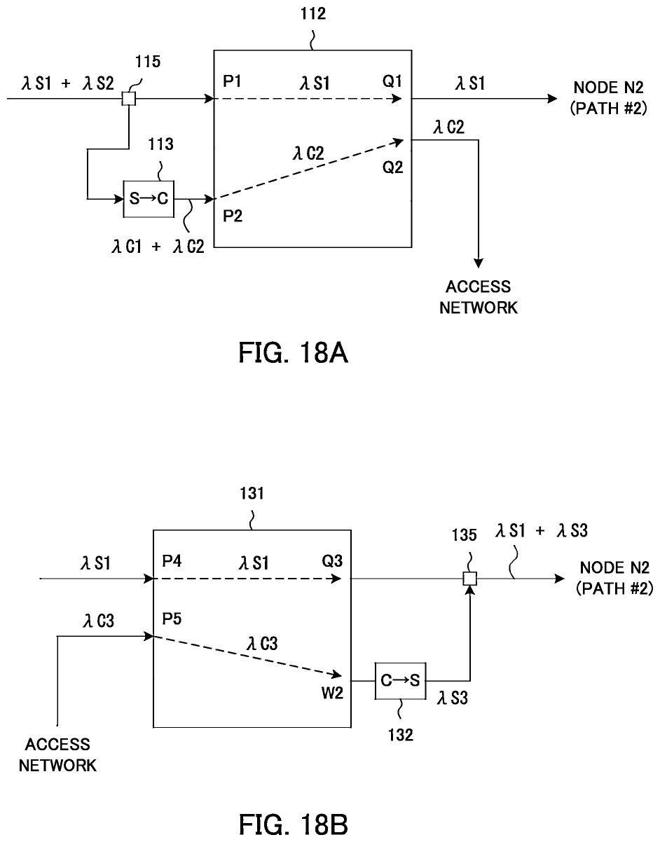

FIG. 18A illustrates an example of an operation of the reception circuit 110C in the third embodiment. In this embodiment, similarly to the case illustrated in FIGS. 8A and 8B or FIGS. 14A and 14B, the optical signal λS1 and the optical signal λS2 arrive at the input port P1. However, the optical signal λS1 and the optical signal λS2 are also guided to the wavelength converter 113 by the optical splitter 115. The wavelength converter 113 performs wavelength conversion from the S band to the C band on the optical signal λS1 and the optical signal λS2 to generate an optical signal λC1 and an optical signal λC2.

The WSS 112 guides an optical signal to be transmitted to another node among the optical signals arriving at the input port P1 to a corresponding port. In this example, the optical signal λS1 is guided to the output port Q1. Note that a destination of the optical signal λS2 is the access network, and the optical signal λS2 is not guided to any port. In addition, the WSS 112 guides an optical signal to be transmitted to the access network among the optical signals arriving at the input port P2 to a corresponding port. In this example, the optical signal λC2 is guided to the output port Q2. Note that a destination of the optical signal λC1 is another node, and the optical signal λC1 is not guided to any port. As a result, the optical signal λS1 is transmitted to the other node, and the optical signal λC2 is transmitted to the access network.

FIG. 18B illustrates an example of an operation of the transmission circuit 130C in the third embodiment. In this example, the optical signal λS1 arrives at the input port P4, and the optical signal λC3 arrives at the input port P5. The WSS 131 guides the optical signal allocated in the S band to the common output port Q3 and guides the optical signal allocated in the C band to the wavelength conversion port W2. In this example, the optical signal λS1 is guided to the output port Q3, and the optical signal λC3 is guided to the wavelength conversion port W2. Then, the wavelength converter 132 generates an optical signal λS3 by performing wavelength conversion from the C band to the S band on the optical signal λC3. Then, the optical signal λS1 and the optical signal λS3 are combined and transmitted to the destination node.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. An optical communication device that processes a WDM signal in a WDM transmission system, the optical communication device comprising:
a reception circuit that receives a first WDM signal from a first node in the WDM transmission system; and
a transmission circuit that transmits a second WDM signal to a second node in the WDM transmission system,
wherein the reception circuit includes
a wavelength filter that extracts a plurality of input optical signals allocated in a first wavelength band from the first WDM signal,
a wavelength selective switch that has a first input port, a second input port, a plurality of output ports, and a wavelength conversion port, and
an optical circuit including a wavelength converter optically coupled to the wavelength selective switch,
the plurality of input optical signals are guided to the first input port,
the wavelength selective switch guides an optical signal to be branched from the first WDM signal among the plurality of input signals to the wavelength conversion port,
the optical circuit performs wavelength conversion from the first wavelength band to a second wavelength band on the optical signal output via the wavelength conversion port to generate a wavelength-converted optical signal,
the wavelength-converted optical signal is guided to the second input port,
the wavelength selective switch guides each of an optical signal to be transmitted to the second node among the plurality of input optical signals and the wavelength-converted optical signal to a corresponding output port among the plurality of output ports, and
the optical circuit guides an optical signal allocated in the first wavelength band among optical signals output via the plurality of output ports to the transmission circuit, and guides an optical signal allocated in the second wavelength band among the optical signals output via the plurality of output ports to an access network connected to the optical communication device.

2. The optical communication device according to claim 1, wherein
the optical circuit includes a second wavelength filter that extracts each of the optical signal in the first wavelength band and the optical signal in the second wavelength band, and
at least some of the plurality of output ports are optically coupled to the second wavelength filter.

3. The optical communication device according to claim 1, wherein
the transmission circuit includes
a second wavelength selective switch that has a common output port and a second wavelength conversion port, and
a second wavelength converter optically coupled to the second wavelength conversion port,
the second wavelength selective switch guides, to the second wavelength conversion port, an optical signal to be transmitted from the access network to the second node and allocated in the second wavelength band,
the second wavelength converter performs wavelength conversion from the second wavelength band to the first wavelength band on the optical signal output via the second wavelength conversion port to generate a second wavelength-converted optical signal, and
the second wavelength selective switch outputs the optical signal arriving at the transmission circuit from the reception circuit and the second wavelength-converted optical signal via the common output port.

4. An optical communication device that processes a WDM signal in a WDM transmission system, the optical communication device comprising:
a reception circuit that receives a first WDM signal from a first node in the WDM transmission system; and
a transmission circuit that transmits a second WDM signal to a second node in the WDM transmission system,
wherein the reception circuit includes
a wavelength filter that extracts a plurality of input optical signals allocated in a first wavelength band from the first WDM signal,
a wavelength selective switch that has a first input port, a second input port, and a plurality of output ports, and
a wavelength converter that performs wavelength conversion from the first wavelength band to a second wavelength band on the plurality of input optical signals to generate a plurality of wavelength-converted optical signals,
the plurality of input optical signals are guided to the first input port,
the plurality of wavelength-converted optical signals are guided to the second input port,
the wavelength selective switch guides an optical signal to be transmitted to the second node among the plurality of input signals to an output port optically coupled to the transmission circuit among the plurality of output ports, and
the wavelength selective switch guides an optical signal to be transmitted to an access network among the plurality of wavelength-converted optical signals to an output port optically coupled to a device connected to the access network among the plurality of output ports.

5. The optical communication device according to claim 4, wherein
the transmission circuit includes
a second wavelength selective switch that has a common output port and a second wavelength conversion port, and
a second wavelength converter optically coupled to the second wavelength conversion port,
the second wavelength selective switch
guides an optical signal arriving at the transmission circuit from the reception circuit to the common output port, and
guides, to the second wavelength conversion port, an optical signal to be transmitted from the access network to the second node and allocated in the second wavelength band,
the second wavelength converter performs wavelength conversion from the second wavelength band to the first wavelength band on the optical signal output via the second wavelength conversion port to generate a second wavelength-converted optical signal, and
the optical signal output via the common output port and the second wavelength-converted optical signal are combined.
